(19) United States
(12) Patent Application Publication
(10) Pub. No.: US 2014/0006406 A1
(43) Pub. Date: Jan. 2, 2014

(54) SYSTEMS AND METHODS FOR ANALYZING AND MANAGING ELECTRONIC CONTENT

(71) Applicants: Oscar D. Kafati, New York, NY (US); Aaron Dabbah, Hartsdale, NY (US); Rami Cohen, Ashkelon (IL); Amit Zvi Gelibter, Givataim (IL); Roey Yaniv, Raanana (IL)

(72) Inventors: Oscar D. Kafati, New York, NY (US); Aaron Dabbah, Hartsdale, NY (US); Rami Cohen, Ashkelon (IL); Amit Zvi Gelibter, Givataim (IL); Roey Yaniv, Raanana (IL)

(73) Assignee: AOL Inc.

(21) Appl. No.: 13/536,672

(22) Filed: Jun. 28, 2012

(51) Int. Cl. G06F 17/30

(52) U.S. Cl. CPC G06F 17/30598
USPC 707/738

(57) ABSTRACT

Systems and methods are provided for identifying and analyzing electronic content in a network environment. In accordance with an implementation, a computer-implemented method is provided for scoring at least one topic in a network environment. The method includes identifying, with at least one processor, a plurality of content items accessible through a network and identifying content items as corresponding to a topic, based at least in part on the contents of the content items. In addition, for each determined topic, the method includes creating a cluster corresponding to the topic, and for each content item associated with the topic corresponding to the created cluster, creating a reference to the content item in the cluster, selecting a representative title to represent the cluster, based on first criteria, and generating a score for the cluster, based at least in part on the number of content items in the cluster.

### BACKGROUND

1. Technical Field

The present disclosure generally relates to computerized systems and methods for analyzing and managing content, such as electronic content published on the Internet or other networks or distribution channels. More particularly, and without limitation, the present disclosure relates to systems and methods for clustering content (e.g., news articles or other content items) concerning a related topic and determining the significance of the topic based on the number of stories. Embodiments of the present disclosure also relate to techniques for ranking and generating a score for these topics based on importance, as well as techniques for presenting data to users based on the topics, their scores, and/or their associated articles.

2. Background Information

The Internet provides hundreds of news outlets and publisher websites. From small-scale websites that are locally-focused, such as Patch.com, to larger news outlets like CNN and the New York Times, these news outlets or “news sites” provide an endless variety of information on an ever increasing variety of topics. For example, a story on the Super Bowl might constitute a less-relevant story on a larger website. However, the star quarterback's hometown news sites might publish their own stories about the same event. While the stories are clearly different in exposure value, length, content, and location, they are both about the same event or “topic” and give a broader view of the event to readers.

Topics can be ranked in order to determine the most important stories. Typically, this is an editorial process. In paper newsrooms, editors may determine, based on the stream of news coming across their desk, which stories will be published on the first page and which will be “below the fold” or on a subsequent page. This can be time-consuming and inaccurate.

Additionally, conventional techniques for retrieving information about a particular topic are not well-suited for finding out information on topics—only on words that might be associated with the topics. For example, a news alert for “AOL” might return news stories about AOL Incorporated. However, it could also return news items that merely mention that string of letters—for example, an email address ending in “aol.com,” news stories that come from an AOL-owned website but do not contain information concerning AOL directly, or groups called the “Art of Living” whose abbreviation happens to be “aol.” This information would likely not be helpful to a user interested only in the company.

In view of the foregoing, there is a need for improved systems and methods for efficiently analyzing and managing electronic content in a network environment, such as the Internet. Moreover, there is a need for improved systems and methods for identifying content items, such as news articles and other electronic content, dispersed across multiple websites. There is also a need for such systems and methods that can efficiently determine topics and rank the importance of those topics, while being implemented in a computer-based environment.

### SUMMARY

The present disclosure includes embodiments for analyzing and managing electronic content in a network environment, such as the Internet. By way of example, the present disclosure encompasses systems and methods for identifying content items (e.g., news articles or other published content) concerning a related topic and determining the significance of the topic based on the number of stories. Embodiments of the present disclosure also relate to techniques for ranking and generating a score for these topics based on importance, as well as techniques for presenting data to users based on the topics, their scores, and/or their associated articles.

In accordance with certain embodiments, systems and methods are provided for clustering news articles concerning a related topic and determining the significance of the topic based on the number of stories.

The present disclosure are provides embodiments for providing a score for a news story, a news event, or topic, based on one or more of: the number of news sources covering that particular story, event, or topic; the number of major news outlets reporting on that story, event, or topic; the amount of original content being reported about that story, event, or topic; and the amount of original content from a major news outlet.

The exemplary embodiments of the present disclosure, including those described below, permit ranking of topics, generation of scores based on importance of topics, presentation of data related to topics, news alerts, and/or other factors.

In accordance with one embodiment, a computer-implemented method is provided. The method comprises identifying, with at least one processor, a plurality of content items accessible through a network, and identifying content items as corresponding to a topic, based at least in part on the contents of the content items. The method also includes, for each determined topic, creating a cluster corresponding to the topic, creating a reference to each content item that is associated with the topic, selecting a representative title to represent the cluster based on first criteria, and generating a score for the cluster based at least in part on the number of content items in the cluster.

In accordance with some embodiments, the computer-implemented method can base the score on each content item that comprises original content, can select a representative title based on repeated terms in titles/headlines of each content item in the cluster or the title/headline of a content item that has the most words overlapping with other content items in the cluster, can generate a score or value for each content item in the cluster, and close clusters once no new articles have been received that correspond to the closed cluster's topic.

In accordance with another embodiment, a system is provided that contains a storage device and at least one processor. The storage device contains a set of programmable instructions. The processor executes the programmable instructions, and performs a method that comprises identifying a plurality of content items accessible through a network and identifying content items as corresponding to a topic, based at least in part on the contents of the content items. The method performed by the at least one processor may further include, for each determined topic, creating a cluster corresponding to the topic, creating a reference to each content item that is associated with the topic, selecting a representative title to represent the cluster based on first criteria, and generating a score for the cluster based at least in part on the number of content items in the cluster.

In accordance with some embodiments, the at least one processor can base the score on each content item that comprises original content, can select a representative title based on repeated terms in titles/headlines of each content item in the cluster or the title/headline of a content item that has the most words overlapping with other content items in the cluster, can generate a score or value for each content item in the cluster, and close clusters once no new articles have been received that correspond to the closed cluster's topic.

It is to be understood that both the foregoing general description and the following detailed description are exemplary and explanatory only, and are not restrictive of the invention as claimed. Further, the accompanying drawings, which are incorporated in and constitute a part of this specification, illustrate embodiments of the present disclosure and together with the description, serve to explain principles of the invention as set forth in the accompanying claims.

### BRIEF DESCRIPTION OF THE DRAWINGS

FIG. 1 illustrates an exemplary network environment, consistent with embodiments described herein.

FIG. 2A illustrates an exemplary method for identifying and gathering stories about the same topic into a cluster, consistent with embodiments described herein.

FIG. 2B illustrates an exemplary method for determining the importance of a particular topic based on the number of stories in a cluster, consistent with embodiments described herein.

FIG. 3 illustrates an exemplary method for selecting information to represent the cluster for display to users, consistent with embodiments described herein.

FIG. 4 illustrates an exemplary method for modifying clusters of news stories, consistent with embodiments described herein.

FIG. 5 illustrates an exemplary electronic device, consistent with embodiments described herein.

FIG. 6 illustrates an exemplary display of the information stored in clusters, as may be displayed to a user, consistent with embodiments described herein.

FIG. 7 illustrates an exemplary display of the information stored in clusters, as may be displayed to a user, consistent with embodiments described herein.

### DESCRIPTION OF EXEMPLARY EMBODIMENTS

Reference will now be made in detail to embodiments of the present disclosure, examples of which are illustrated in the accompanying drawings. The same reference numbers will be used throughout the drawings to refer to the same or like parts.

In this application, the use of the singular includes the plural unless specifically stated otherwise. In this application, the use of “or” means “and/or” unless stated otherwise. Use of the indefinite article “a” or “an” is meant to include one or more than one of the feature that it introduces, unless otherwise indicated. Furthermore, the use of the term “including,” as well as other forms such as “includes” and “included,” is not limiting. In addition, terms such as “element,” “block,” or “component” encompass elements, blocks, and components comprising one unit, and elements, blocks, and components that comprise more than one subunit, unless specifically stated otherwise. Additionally, the section headings used herein are for organizational purposes only, and are not to be construed as limiting the subject matter described.

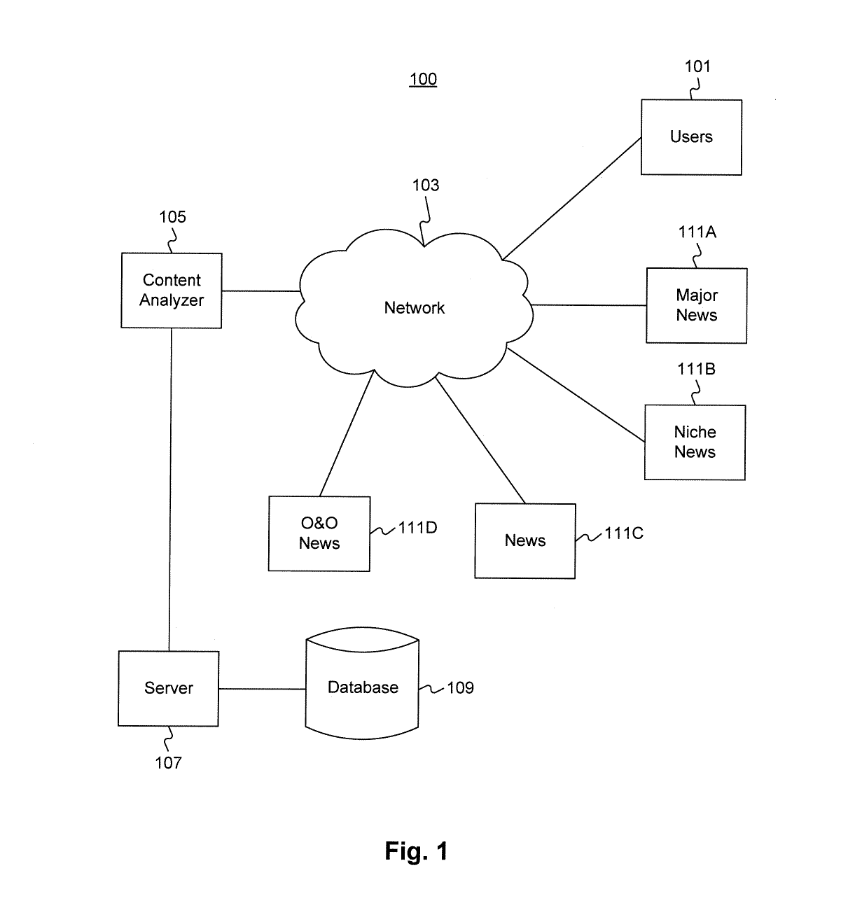

FIG. 1 illustrates an exemplary network environment 100, consistent with embodiments of the present disclosure. As shown in FIG. 1, network environment 100 includes one or more Users 101, News Sites 111A-111D, Content Analyzer 105, Server 107, and Database 109. These components may be configured to communicate and share data with one another using direct electronic communication channels or by electronic communication via Network 103.

Users 101 represent one or more users who access and view information using a device (such as a computer, server, laptop, smartphone, mobile device, PDA, or other device). Users 101 may access and view information from, among other sources, any of News Sites 111A-111D or Server 107. In some embodiments, Users 101 may also access Content Analyzer 105 and Database 109. In other embodiments, Users 101 may only access Content Analyzer 105 and Database 109 indirectly (i.e., through another device or system, such as Content Analyzer and/or Server 107).

As noted above, Network 103 may allow electronic communication between the various components of FIG. 1, such as Users 101, News Sites 111A-111D, Content Analyzer 105, Server 107, and Database 109. Any of Users 101, News Sites 111A-111D, Content Analyzer 105, Server 107, and Database 109 may be connected directly or indirectly to Network 103. For example, any of components 105, 107, and 109 may be connected directly or through another device (such as a router, bridge, gateway, hub, proxy server, another network, or the like).

In some embodiments, Network 103 may be implemented using one or more conventional networks, including wired and wireless networks. By way of example, Network 103 may comprise the Internet. Additionally, or alternatively, Network 103 may comprise any of a cellular network, a wireless (i.e. IEEE 802.11a, b, g, or n) network, an Ethernet network, and/or other types of conventional networks that support electronic communication between components or devices.

Content Analyzer 105 can monitor any or all of Major News 111A, Niche News 111B, News 111C, and O&O News 111 D to identify news articles or other content appearing on these sites. In some embodiments, Content Analyzer 105 may determine the subject matter of each news article and/or other content in order to determine what the article or content is actually about (e.g., a particular topic of the article). In some embodiments, Content Analyzer 105 may also determine the more general subject matter or “event type” of each topic (e.g., election results, celebrity divorce scandals, rugby scores, etc). Additionally, in some embodiments, Content Analyzer 105 may also determine the source of a news article or other content (e.g., whether it comes from a site such as Major News 111A or Niche News 111B or a news agency such as the Associated Press). Content Analyzer 105 may also analyze the source in order to determine how reliable and trustworthy a particular article or other content is in terms of accuracy, originality, etc.

Content Analyzer 105 can also determine the reliability of that News Site for that particular subject. For example, Content Analyzer 105 could determine that a tech-focused website is very reliable for news articles about new electronic gadgets, but is not as reliable for content related to political information. Content Analyzer 105, in some embodiments, may be implemented using AOL's Relegence system, which simultaneously monitors thousands of content sources—e.g. News Sites, blogs, videos, news wire services, headlines, television networks—to discern information about topics. However, Content Analyzer 105 can be implemented using any appropriate system or product.

As shown in FIG. 1, Server 107 may be connected to Network 103 through Content Analyzer 105. However, as mentioned above, may also be connected to Network 103 using its own connection. Server 107 may collect or receive data from Content Analyzer 105. This data, in some embodiments, includes information about the news articles or other content monitored by Content Analyzer 105 on, for example, News Sites 111A-111D, information about News Sites 111A-111D, information about Users 101, information about Network 103, and so on. This data, in some embodiments, is used to send other data back to Users 101, News Sites 111A-111D, Network 103, Database 109, and the like. For example, a user may receive information on a trending topic via a “news alert.” This information, in some embodiments, may be based on the data received by Content Analyzer 105 and/or Server 107. In some embodiments, Server 107 is a web server or cluster of servers which receives requests from Users 101 and serves web pages or electronic content to requesting Users 101.

Database 109 is, in some embodiments, connected to Network 103 through Server 107. However, Database 109 may be connected to Network 103 through its own connection. In some embodiments, Database 109 receives, stores, and sends information from and to Users 101, Content Analyzer 105, Server 107, and/or News Sites 111A-111D. In some embodiments, Database 109 stores information concerning the operation of Server 107 and Content Analyzer 105, such as cluster data, topics, tags, images, cluster start times, and/or other information. Database 109, in some embodiments, also stores information about the interests of Users 101.

Major News 111A, Niche News 111B, News 111C, and O&O (Owned-and-Operated) News 111 D are all examples of web sites that produce content in the form of electronic news articles, news feeds or wires, blog posts, videos, message alerts, headlines, and the like. This electronic content may contain information about events, topics, news of the day, breaking news, sports news, financial news, and the like. Each of News Sites 111A-111D may contain identical, similar but not identical, or dissimilar information on the same topic. For example, given the same event (e.g., the construction of a new stadium), a News Site that delivers news primarily about a particular sports team might deliver one kind of information about the event (e.g. concessions, parking, what teams will play there), while a News Site that delivers news primarily about financial information might deliver another kind of information (e.g. the investors backing the stadium's construction, the new owners' financial reports, etc.) These stories, while having different information, can be said to have the same topic, because they both refer to the construction of the new stadium.

Major News 111A is an example of a major news outlet. These news sites focus on all types of news. While they may, in some embodiments, be regional in focus, Major News 111A could also be a more globally-focused news provider. Major News 111A, for example, could be a widely-read source such as the New York Times or CNN.com. Major News 111A could also be a news source such as the Associated Press or Reuters.

Niche News 111B is an example of a more focused news outlet. Niche News 111B could be, for example, a web site that caters to technology enthusiasts or those interested in finance. These sites, in some embodiments, would provide articles about the same stories as Major News 111A, but with a different focus.

News 111C is a more general example of a news outlet. Any or all news outlets may be seen as News 111C. This could include, for example, smaller regional news outlets, blogs, local newspapers, and the like.

O&O News 111 D is an example of a news outlet owned by a particular company. For example, a company that operates Content Analyzer 105, Server 107, and/or Database 109 may own and operate one or more of its own O&O News sites. Thus, the company operating Content Analyzer 105 may have a financial incentive to promote the articles that appear on their own O&O News sites, and thus may favor those articles more than other articles. Favoring these articles, in some embodiments, can comprise promoting them more frequently, choosing them as primary, or “alpha” articles more frequently, using any images in those articles as the representative image, and the like. The same is true with other forms of electronic content.

The particular network environment shown in FIG. 1 is provided for purposes of illustration. The exemplary embodiment of FIG. 1 is, therefore, not representative of the only network environment, and other network environments and configurations are possible. In addition, there may be more than one of each of Users 101, News Sites 111A-111D, Content Analyzer 105, Server 107, and Database 109. Editors, Operators, and Implementers typically operate Content Analyzer 105, Server 107, and/or Database 109, and can both manually modify and directly access the data stored therein, as will be described below.

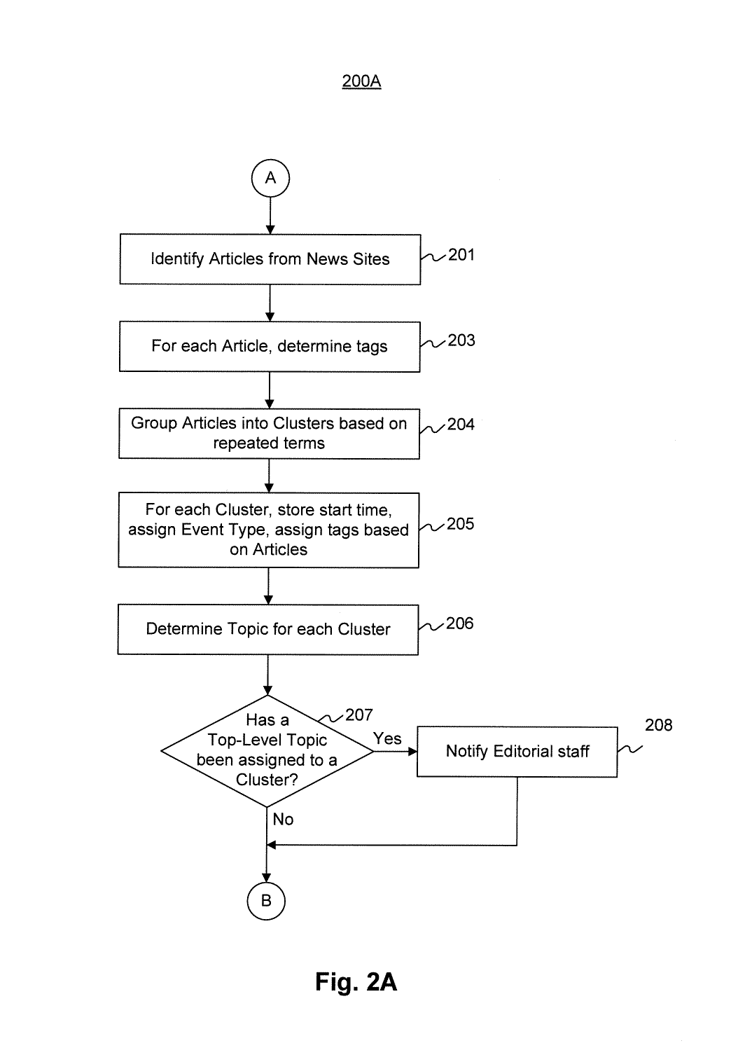

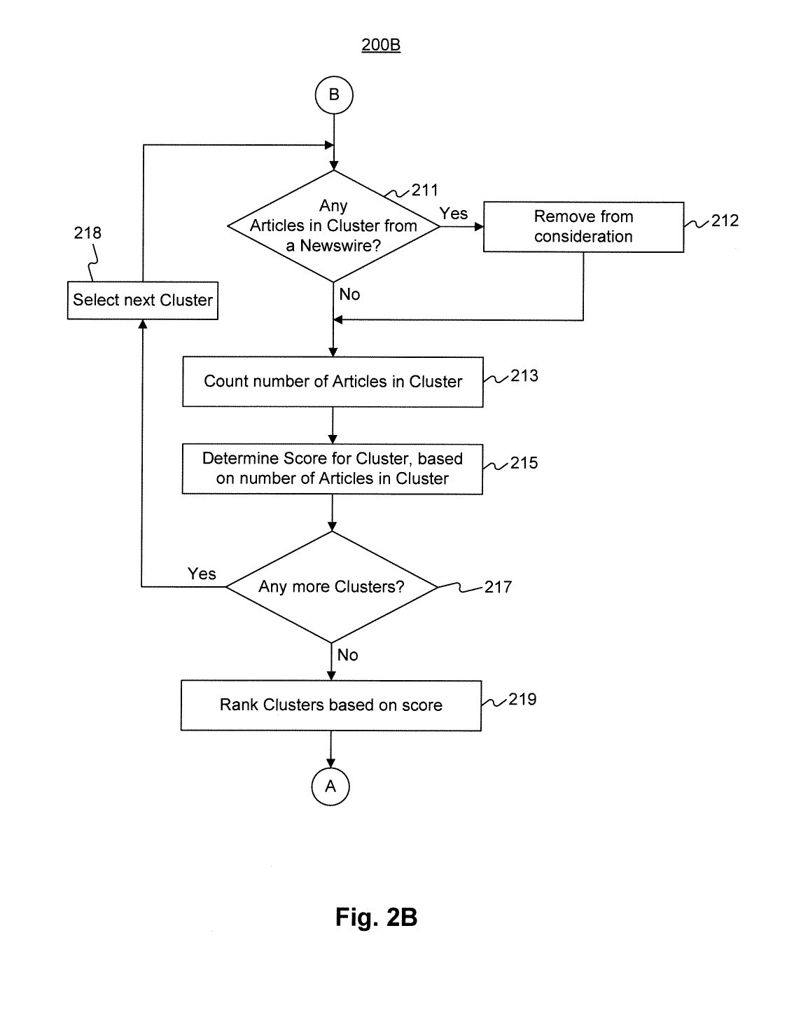

FIG. 2A is an exemplary method 200A for identifying and gathering stories about the same topic into a cluster, consistent with embodiments described herein. Embodiments of method 200A may be performed on any or all of Content Analyzer 105, Server 107, or Database 109, as appropriate. The following descriptions for FIG. 2 and other drawings include examples with respect to articles, but it will be appreciated that the exemplary embodiments may be implemented for other forms of electronic content, including news feeds, videos, alerts, messages, headlines, etc.

Referring to FIG. 2, in block 201, news articles are identified from one or more web sites. In some embodiments, this can comprise Content Analyzer 105 identifying and collecting articles from any or all of News Sites 111A-111D. Articles can be identified and collected (alternatively “gathered”) hourly, daily, or in real-time. The collection of articles, in some embodiments, also allows for an automatic collection of any images inside the article and/or URLs of those images. The content of the articles, images, and/or the URL of the images may be stored in any of Database 109, Server 107, and Content Analyzer 105.

Any number of News Sites can be included or excluded from the collecting step represented in block 201 as desired. For example, if the editor of Content Analyzer 105, Server 107, and/or Database 109 operates those sites with a particular political bias, that editor may wish to exclude his/her ideological opponents' web sites from being gathered and clustered. An editor of a liberal web site might want to exclude conservative news sites from being considered during the article identification and collection process in block 201. In some embodiments, block 201 may be performed using keywords, wildcards, a blacklist or whitelist, artificial intelligence, and the like.

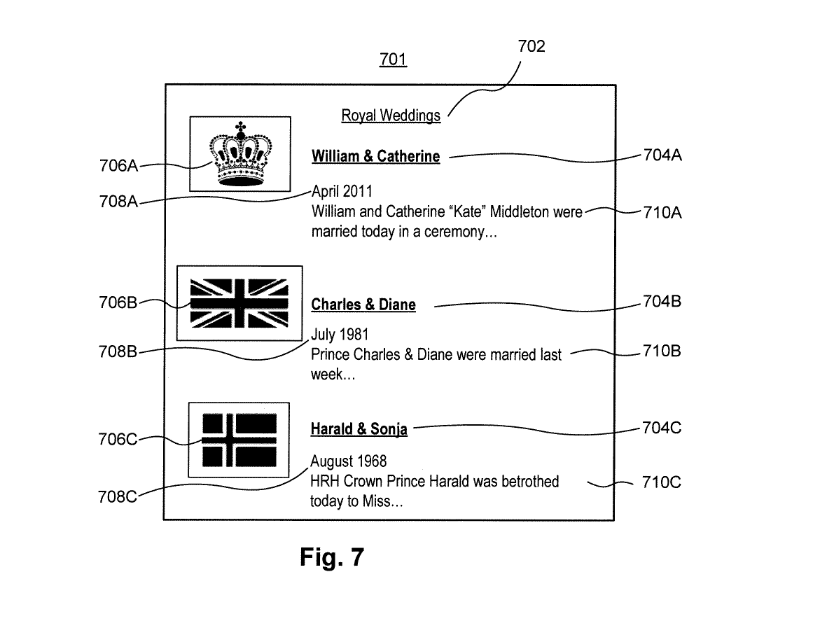

Additionally, historical information and/or news articles can be manually added to these clusters by an editor, as will be described later with respect to FIG. 7. This enables clusters to contain more relevant information on a topic if an editor believes that the clusters concerning the topic are insufficient to represent the full story.

In block 203, each news article is analyzed to determine the tags that are relevant to that article. For some articles, this may comprise only a single tag. For example, a car accident on Interstate 80 might lead to a determination that “accident” is the only tag. For other articles, more tags might be determined.

In some embodiments, Content Analyzer 105 can analyze articles to determine appropriate tags for each story. These tags would ideally be one-word objects, though they could comprise more than one word. Tags can be used to represent some portion of the article. In some embodiments, tags would be used to represent subjects and entities mentioned in the stories. For example, a baseball player named John Smith being traded from the New York Yankees to the Boston Red Sox might generate “Yankees,” “Red Sox,” “John Smith,” “Boston,” “New York,” and “baseball” as tags. The tags that are chosen could be based on the contents of the article itself. These tags could persist in some data store—such as, for example, Content Analyzer 105, Server 107, or Database 109—as being associated with the article. The number of articles associated with each tag can also be stored.

The tags chosen for each article could come from a pre-defined list of subjects and entities. In some embodiments, this list of subjects and entities could be AOL's Taxonomy system, which stores a large list of subjects and entities, such as celebrities, sports teams, politicians, companies, current issues, and the like. However, any list, system, or methodology may provide the tags that are chosen for each article.

In block 204, the identified articles are grouped (or “gathered,” or “collected”) into Clusters based on repeated terms in each article. For example, the system may determine that two articles should be grouped into the same cluster based on the terms “Madonna” and “Guy Ritchie” appearing in both articles. However, the level of granularity (i.e. the number of repeated terms that would appear in each article for said articles to be grouped into the same cluster) could be set to any level and fine-tuned to the implementers' desires. In some embodiments, any article may be gathered into multiple clusters. In other embodiments, each article may be gathered into only the cluster that is the most relevant to the article.

The method continues in block 205. In addition to creating clusters, the event type of the cluster is determined. So, for the traded baseball player example, the “event type” could be “sports trade,” “sports,” or the like. This event type and the time that the cluster was created may be stored, in some embodiments, in any of Content Analyzer 105, Server 107, or Database 109. Additionally, based on the clustering of each article, the tags associated with each article are assigned to the clusters in which the articles are clustered.

After it is determined that a cluster is no longer receiving new or current news articles (e.g., because no news articles have been added to the cluster for a certain amount of time or for a number of article collection events) the cluster may be “closed.” As a result, newly-found articles will not be placed into the cluster.

In some embodiments, a cluster will be for a single event and/or entity; thus, some clusters will contain articles from only a single day. These clusters may be opened and closed on the same day. However, if a cluster from a previous day and a cluster from today are about the same topic, the two clusters can be merged to represent both days of articles.

In block 206, the topic of each cluster is determined. The topic of each cluster is the story or event that the cluster is about. Determination of the topic of each cluster can be made using the tags associated with each cluster, the repeated terms that constituted the basis for clustering the articles together, or portions of both. However, other embodiments are possible and the topic may be also determined using any known process (for example, known subject classification algorithms).

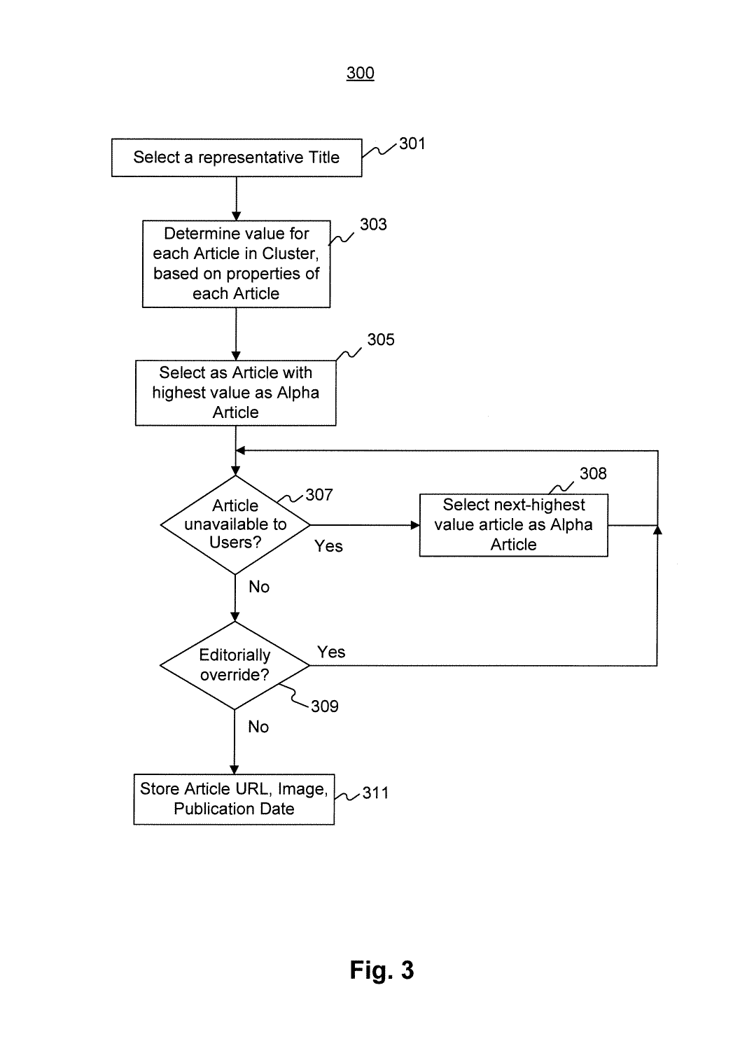

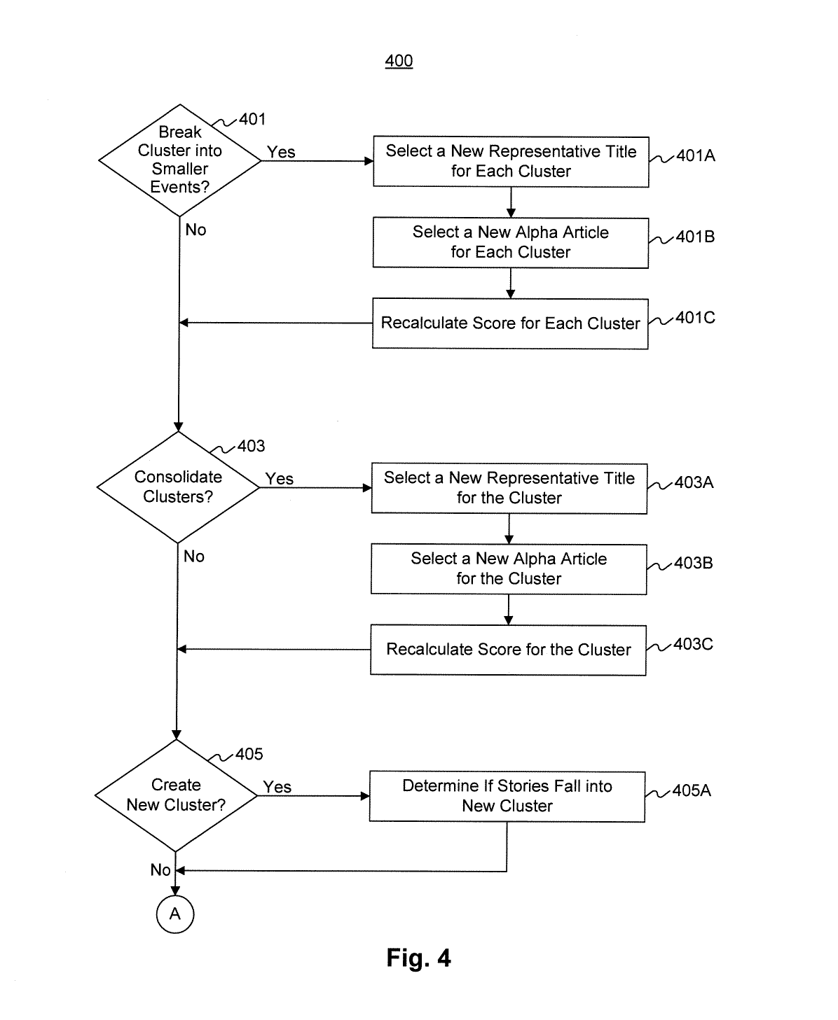

In block 207, a determination is made as to whether a top-level topic has been assigned to a cluster. This portion of method 200A allows an editor or operator of Content Analyzer 105 and/or Server 107 to understand when high-level subjects have been assigned to clusters. If a high-level subject—such as “finance,” “sports,” or “breaking news”—is assigned to a cluster, the contents of the cluster may not be related enough to justify gathering them into the same cluster. For example, if an article about a building collapse in Argentina and another article about a political scandal in Taiwan both receive the tag “breaking news,” then both stories might fall into the same “breaking news” cluster even though they are not related beyond that tag. Thus, if a top-level topic has been assigned to a cluster in block 207, editors can be notified in block 208 to take appropriate action, as covered later in FIGS. 3 and 4.

In either case, the exemplary method of FIG. 2A may eventually continue to FIG. 2B. FIG. 2B is an exemplary method 200B for gathering stories about the same topic into a cluster, consistent with embodiments described herein. Similar to method 200A of FIG. 2A, embodiments of method 200B may be performed on any or all of Content Analyzer 105, Server 107, and Database 109, as appropriate.

Method 200B begins with block 211, where it is determined whether any articles in a cluster are from a newswire source. A “newswire service” (or “newswire”) includes, but is not limited to, the Associated Press (AP), Reuters, the Agence France Presse (AFP), PR Newswire, and the like. Newswires typically produce short articles—or “newswire reports”—about a story or event, and distribute them to their customers. This enables news sources, like News Sites 111A-111D, but not exclusively, to receive timely news updates that they can use in their own reporting. While some news sources may use the newswire articles as a supplement to their own reporting efforts, many news sources choose to republish the newswire article in full, as either part of or the entirety of their report on an event. This is especially true for local or regional news sources that are reporting on major events taking place outside of the normal sphere of interest for that source.

Thus, in block 211, the articles in each cluster are parsed to determine whether any articles in those clusters come from a newswire service. This enables better determination of how relevant or important a story is, by enabling the system to determine which stories were actually authored by individual news outlets and which were merely based on newswire reports (or, as stated previously, merely reprints of newswire reports).

In some embodiments, articles that are verbatim copies of newswire reports will be determined to come from a newswire service, but articles that are substantially composed of newswire reports (i.e. only a small portion of the article differs from the newswire report) will be counted as individual articles. In other embodiments, both articles that are verbatim copies of newswire reports as well as articles that are substantially composed of a newswire report will not be counted. What constitutes “substantially composed” may be a threshold percentage set by editors, such that an article will be counted as an “original article” if the percentage of the article that is composed of a newswire report is less than the threshold.

If any articles are determined to be based on newswire reports, these articles may, in some embodiments, be removed from consideration in calculating the importance of the story. This is represented in block 212 of FIG. 2B.

In any case, method 200B then continues to block 213, where the number of articles in the cluster is determined. This may be calculated based simply on the number of articles in the cluster, or it may account for the newswire articles as mentioned in block 211 by not double-counting articles from newswires.

Method 200B then moves to block 215, where a score is determined based at least in part on the number of articles in the cluster. This score may be referred to as a “MagScore.” As mentioned previously, this score may be based in part on the number of articles in the cluster. In some embodiments, as mentioned previously, this score may be a counting-up of the number of articles in the cluster.

In some embodiments, the score for the cluster may be determined based on one or more of: the number of articles in the cluster, the number of individual sources represented by the articles in the cluster, the number of “preferred” sources represented by the articles in the cluster (i.e. based on a list of sources stored in the system that are remembered as “preferred” sources), the number of O&O (owned and operated) sources represented by the articles in the cluster, and the number of “original articles” (as described in part above with reference to block 211. In some embodiments, attributes are weighted differently. For example, when calculating the score for the cluster, the number of O&O sources represented by the articles in the cluster may be weighted twice as much as the number of “preferred” sources represented by the articles in the cluster.

After determining the score for the cluster, method 200B moves to block 217, where the method determines whether there are any other clusters that have not yet been scored. If so, the method moves to block 218, where the next cluster is selected and method 200B proceeds to block 211 to count and score the articles in the next cluster. In some embodiments, this process will continue—that is, by operating any or all of the steps represented in blocks 211-217—until all clusters have been scored.

If, as mentioned before, all articles in all clusters have been counted, and all clusters have been scored, the process will continue to block 219, where each cluster will be ranked at least in part based on each cluster's score. These rankings can be used, for example, to determine the most significant event or story currently happening. After ranking the clusters, the process can continue through block A, back to FIG. 2A, block 201, to collect any new articles. As mentioned before, the acquisition of articles can be done on any time schedule, including (but not limited to) real-time, hourly, daily, weekly, and the like.

FIG. 3 is an exemplary method 300 for selecting information to represent the cluster for display to users, consistent with embodiments described herein. Similar to method 200A in FIG. 2A, embodiments of method 300 may be performed on any or all of Content Analyzer 105, Server 107, or Database 109, as appropriate. This method, in some embodiments, could be performed on each cluster generated by the methods in FIGS. 2A and 2B. However, it need not be performed on each cluster and may be overridden, for example, by editorial staff.

Method 300 may, in some embodiments, begin with step 301, where a title representing the cluster is selected. This title preferably should describe the overall story or event that is referenced by the articles in the cluster. In some embodiments, a title may be chosen by determining repeated terms/phrases in the headlines of each article—or a majority of articles—in the cluster. A headline could then be generated that represents the content of the cluster. However, the title could be manually selected or edited by a user, editor, or another system. In some embodiments, this could be done in an effort to garner a certain level of interest in the cluster.

To continue with the above baseball player example, this would enable a headline for a cluster concerning the trade to relate more clearly to the teams and player involved in the transaction, because these words are likely to appear in a multitude—if not a majority—of the articles on the story. In some embodiments, the title chosen for the cluster would be a headline from the article that has the most words that overlap with the other articles' headlines. Similar to the steps in method 200B concerning the double-counting of newswire article-based stories, accounting for these articles by disregarding newswire articles may, in some embodiments, factor into selecting the title.

After selecting the title in block 301, method 300 may proceed to block 303, where a value (or “alpha article score”) is generated for each article in the cluster. The alpha article score of each article may be a factor of the properties of the article in question. The properties may include, for example: whether the article is from an O&O (Owned and Operated) website, whether the article is from a major news source, whether the article is the most recent article on the topic, whether the article is the longest article in the cluster, or whether the article contains an image. Examination of articles for these properties will now be explained.

O&O website: As mentioned before, an O&O website may be owned by the same the company that operates Content Analyzer 105 (from FIG. 1). Thus, the company operating Content Analyzer 105 may have a financial incentive to promote an article and may thus increase the alpha article score generated for an article.

Major news source: As mentioned before, these news sites focus on all types of news. While major news sources may, in some embodiments, be regional in nature, major news sources would preferable be a more globally-focused news provider. For example, examples of a major news source could be a widely-read source such as the New York Times or CNN.com or newswire services such as the Associated Press or Reuters. In some embodiments, what constitutes a “major news source” could be a site that specializes in the particular topic that a cluster is concerned with. For example, if a new model of MP3 player is released, a technology news site—for example, Engadget.com—may constitute a “major news site” for a story about the new MP3 player. Thus, an article from a major new source may have a higher alpha article score than another similarly-situated article.

Most recent article: The most recent article in the cluster could, in some embodiments, be given a higher alpha article score based on being the most recent article.

Longest article: In some embodiments, the method in block 303 would determine alpha article scores based on length. A threshold can be set by an editor, user, or automated system. For example, the threshold value could be set to 100 words, so as to avoid increasing the alpha article score for an article merely stating “This is a breaking news update, check back for updates.” In some alternative embodiments, block 303 could determine whether there are any articles that are shorter than a certain length, and increase the alpha article score of those articles by a certain amount. This would enable the entire article to fit in a preview of the article, which may be desired by the operators or editors of the inventive systems.

Articles with images: In some embodiments, the method in block 303 could determine alpha article scores based on whether each article has a relevant image. The method could determine whether the image is relevant to the article or is merely an unrelated stock image. For example, embodiments could determine that an article with a logo reading “BREAKING NEWS” would not necessarily constitute an article that has an image, because this image is not relevant to the article's actual contents and may have been repeated between articles of that type.

The determinations made in block 303 may be performed in any combination and to any end. As a first example, whether the article comes from an O&O website is not important. Thus, an article's alpha article score will not change based on its source being an O&O website. As a second example, whether an article has an image is not determined to be as important as the other factors. Thus, if an article has an image, the alpha article score could be increased by 1 out of a possible score of 100. As a third example, whether an article has an image is determined to be a large factor in the alpha article score. Thus, an article with an image could be increased by 75 out of 100. However, the choice of these particular values/scores, ranges, properties, and levels of importance is not limiting; they are merely for demonstrative purposes.

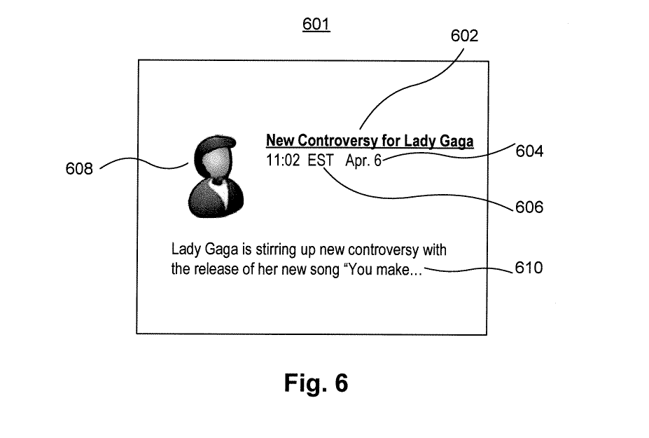

After determining alpha article scores for each article in the cluster, the method can continue to block 305. In block 305, the article with the highest alpha article score is selected as the alpha article. This may be done by writing data into any of Database 109, Server 107, and Content Analyzer 105 from FIG. 1, or to any other device that stores data related to the system. This alpha article can be used to represent the cluster to a user. For example, this article can be reprinted in part when a user attempts to access data related to the cluster (as will be referenced later in exemplary FIGS. 6 and 7).

The method then may proceed to block 307, where the system may determine whether the alpha article is actually available to external users. For example, portions of some news sites are available to the public without a subscription, while other portions are unavailable. Thus, selecting an article from a news site that may not be available to all users may present a problem, in that users interested in learning more about the topic may not be able to access the representative article about the topic. Thus, an optional step in method 300 is selecting a new article—that is, excluding the selected alpha article from consideration as in block 307 and determining a new alpha article by choosing the article with the next-highest alpha article score. The method may then proceed back to block 307 to determine whether the article with the next-highest alpha article score is unavailable to external users. This may continue until an article with the highest alpha article score that is also available to external users is chosen.

After choosing an alpha article that is available to external users, the method may then proceed to block 309. Block 309 allows an editor to override the selection of that alpha article by manually indicating a selection of a new alpha article. This creates a system by which an editor can select an article that he would rather have as the alpha article, in case the method steps in blocks 303-308 do not yield an article that the editor wishes to have as the alpha article. The steps represented by block 309 are optionally followed by a determination of whether the editorially-chosen article is actually available to external users as in block 307; however, this is not a required determination. In some embodiments, the steps represented by block 309 may be performed at any point in method 300, including before any other steps of method 300.

In any case, the method then may proceed to block 311, where the URL of the alpha article, any images from the alpha article, and the publication date of the alpha article are all stored. This information may be useful in representing the cluster to users. For example, the article text, the URL, the image, and/or the publication date may be reprinted in part when a user attempts to access data related to the cluster (as will be referenced later in exemplary FIGS. 6 and 7).

Images can be excluded from storage if the URL is “broken” (i.e. inaccessible) or the image is unavailable in any sense (e.g. unavailable on a second attempt to access, unavailable to general users, etc.) Images can also be filtered by size; that is, editors or operators of the system can specify the types, sizes, colors, content, and the like, of the images that will be stored to represent the cluster.

FIG. 4 is an exemplary method 400 for editorially modifying clusters of news stories, consistent with embodiments described herein. Method 400 further expands on editorial power over the clusters in the system. Similar to method 200A in FIG. 2A, embodiments of method 400 may be performed on any or all of Content Analyzer 105, Server 107, and Database 109, as appropriate.

In block 401, a determination is made as to whether an editor has attempted to break a cluster into smaller events. For example, imagine an accounting scandal at a large energy group. This scandal eventually leads to the dissolution of the company and a collapse of the accounting firm that worked for the large energy group. While a cluster may be composed of the entire set of events—from the scandal's beginnings to the collapse of the accounting firm involved—an editor may decide that this cluster would be served better if represented as multiple clusters. In this example, an editor might decide that one cluster should represent the accounting scandal, a second cluster should represent the story about the collapse of the company, and a third cluster should represent the fallout and collapse of the accounting firm involved. Of course, this is merely exemplary and any set of stories, clusters, articles, and/or events can be used in this manner.

In any case, if an editor has requested to break a cluster into smaller events, the method continues to block 401A where a new representative title is selected for each cluster. This process can be done, for example, substantially as previously described with respect to FIG. 3.

Method 400 may then proceed to block 401B, where a new alpha article is selected to represent each cluster. This process can be done, for example, substantially as previously described with respect to FIG. 3.

Method 400 may then proceed to block 401C, where a new score is calculated for each cluster. This calculation can be done, for example, substantially as previously described with respect to FIG. 2B.

After determining that an editor has not decided to break the cluster into smaller clusters in block 401, or after recalculating the score for each cluster in block 401C, method 400 may continue to block 403. In block 403, a determination is made as to whether an editor has decided to consolidate multiple clusters into a single cluster. If so, steps similar to those in 401A-401C in selecting new cluster titles and alpha articles, and generating new scores, are performed in steps 403A-403C.

After determining that an editor has not decided to consolidate multiple clusters into a single cluster in block 403, or after recalculating the score for a new cluster in block 403C, method 400 may continue to block 405. In block 405, a determination is made as to whether an editor has decided to create a new cluster manually. For example, if a popular music group has released a new album but no cluster has appeared to collect the news articles about the release, an editor may create a new cluster and associate tags with it to collect relevant news articles as they become available. If an editor has created a new cluster, the method continues to block 405A, where previously-gathered articles are searched through to determine whether they should be classified and stored in the newly-created cluster.

In some embodiments, after the steps in either block 405 or 405A are executed, the method continues back to FIG. 2A through block A. However, as the makeup of clusters may change from second to second, the steps represented by method 400 may be performed at any reasonable point, and in any reasonable order, during the operation of the system. This includes, but is not limited to, before, during, or after the operation of any portion of methods 200A, 200B, or 300 on FIG. 2A, 2B, or 3, respectively.

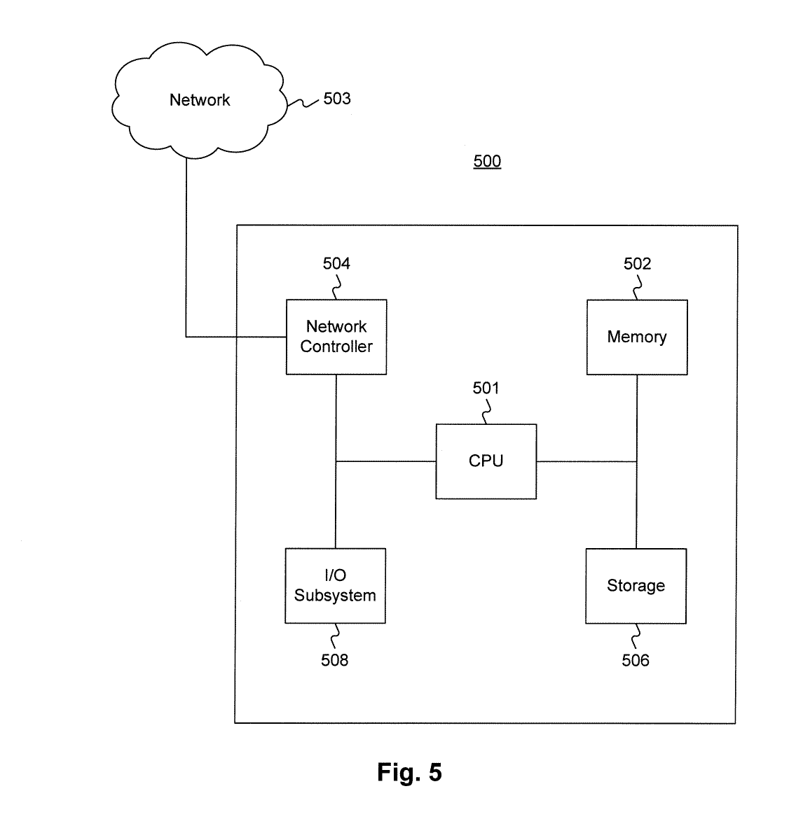

FIG. 5 is an exemplary electronic device 500, consistent with embodiments described herein. Electronic Device 500 may be, for example, a server, a mainframe computer, a personal computer, a tablet PC, a cellular telephone, a Personal Digital Assistant (PDA), or a similar type of computer, computer-type, or computer-based device. The devices described in this disclosure—such as Users 101, News Sites 111A-111D, Content Analyzer 105, Server 107, Database 109, and in some embodiments, Network 103—may all be implemented at least partially as described in FIG. 5.

Each component may include CPU 501, Memory 502, Network Controller 504, Storage 506, and I/O Subsystem 508. Further, each of these components may be implemented in various ways. For example, they may take the form of a general purpose computer, a server, a mainframe computer, or any combination of these components. In some embodiments, the components may include a cluster of servers capable of performing distributed data analysis. They may also be standalone, or form part of a subsystem, which may, in turn, be part of a larger system.

CPU 501 may include one or more known processing devices, such as a microprocessor from the Pentium™ or Xeon™ family manufactured by Intel™, the Turion™ family manufactured by AMD™, or any of various processors manufactured by Sun Microsystems. CPU 501, in some embodiments, may be a mobile processor, such as the Apple™ A5™ or A5X™, the Samsung™ Exynos™, or any of various mobile microprocessors manufactured by other manufacturers. Ideally, CPU 501 represents multi-threading processor(s)—that is, a processor that may operate multiple “threads,” or processing portions, of the same program or different programs at the same time—but this is not required.

Memory 502 may include one or more storage devices configured to store information used by CPU 501 to perform certain functions related to disclosed embodiments. Memory 502 may be composed of any of flash memory, Random Access Memory (RAM), Read-Only Memory (ROM), or any other kind of memory. Storage 506 may include a volatile or non-volatile, magnetic, semiconductor, tape, optical, removable, non-removable, or other type of storage device or computer-readable medium.

In some embodiments, memory 502 may include one or more programs loaded from storage 506 or elsewhere that, when executed by the components, perform various procedures, operations, or processes consistent with disclosed embodiments. In one embodiment, memory associated with Electronic Device 500 may include a program that performs a consistent with the above-recited embodiments.

Methods, systems, and articles of manufacture consistent with disclosed embodiments are not limited to separate programs or computers configured to perform dedicated tasks. Moreover, CPU 501 may execute one or more programs located remotely from the components employing CPU 501. For example, Electronic Device 500 may access one or more remote programs that, when executed, perform functions related to disclosed embodiments.

Memory 502 may be also be configured with an operating system (not shown) that performs several functions well known in the art when executed by CPU 511. By way of example, the operating system may be Microsoft Windows™, Unix™, Linux™, Solaris™, Apple™ iOS™, Google™ Android™, or some other operating system. The choice of operating system, and even the use of an operating system, is not necessarily critical to all embodiments.

Electronic Device 500 may include one or more I/O devices connected through I/O Subsystem 508. This can include, for example, mice and other pointing devices, keyboard, monitors and other display devices, printers and other recordation devices, and the like. I/O devices may also include one or more digital and/or analog communication input/output devices that allow programs to communicate with other machines and devices. Electronic Device 500 may receive data from external machines and devices and output data to external machines and devices via I/O devices. The configuration and number of input and/or output devices incorporated in I/O devices may vary as appropriate for certain embodiments.

Additionally, Electronic Device 500 can also include Network Controller 504 that allows data to be received and/or transmitted over network 503. This can include, for example, token ring, Ethernet, 802.11 wireless, cellular, satellite, and similar network controller types. Network Controller 504 will connect to an appropriate Network 503 for communicating data to and from CPU 501.

FIG. 6 is an exemplary Screen 601 of the information stored in clusters, as may be displayed to a user, consistent with embodiments described herein. Screen 601 is an example of how information collected into clusters is demonstrated to users. In this example, a previously-generated title 602 is displayed to the user, along with date 604 and time 606 of the alpha article. Image 608 from the alpha article (or from another article) is displayed as well. A short preview of the alpha article 610 is also displayed to interest the user.

Any or all of title 602, date 604, time 606, image 608, and preview 610 are “clickable”—that is, are able to be clicked by a user—to initiate the visiting of the alpha article or other information. In some embodiments, when a user clicks on title 602, a list of related articles is displayed to the user. In some embodiments, when the user clicks on date 604, time 606, image 608, or preview 610, the alpha article is displayed to the user. However, the result of clicking any of title 602, date 604, time 606, image 608, or preview 610 may be customized such that different actions occur—such as accessing specific other articles, a random article, a list of articles, or the alpha article.

FIG. 7 is an exemplary Screen 701 of the information stored in clusters, as may be displayed to a user, consistent with embodiments described herein. Screen 701 represents multiple events, clustered into a single group for ease of access. The information displayed on exemplary Screen 701 represents historical royal weddings, as shown by cluster title 702. The first set of information—title 704A—represents the information that ties the related articles together; in this example, the articles that are represented by title 704A would all concern the marriage of William and Catherine. Because this wedding, as shown by date 708A, happened fairly recently, most of these articles could have been collected automatically as described with respect to FIGS. 1, 2A, and 2B. However, with respect to older clusters, such as the ones represented by titles 704B and 704C, many of these articles could have been added manually (as described with respect to FIG. 4), because these weddings occurred before wide distribution of news articles over publically-accessible networks, such as Network 103 in FIG. 1.

As previously mentioned, the information in FIGS. 6 and 7 may be generated manually or automatically. Application Programming Interfaces (APIs) may be used to generate and retrieve data associated with clusters to present the information that is stored in or associated with clusters. In some embodiments, APIs may be used to retrieve clusters based on: a date range, a MagScore, relevance to a particular topic, subject or entity data, and/or a choice of specific sources (e.g. Major News Sites or O&O Sites). Retrievals of data using these APIs may be limited to a maximum number of articles as well. The APIs can be used to give recent events higher weighting in terms of being displayed, even if the clusters related to those events have a lower MagScore than other clusters.

It must be noted that the particular order of each exemplary method is not required. That is, as the makeup of clusters may change from moment to moment, any block of methods 200A, 200B, 300, or 400 may be performed at any reasonable point during the operation of the system. This includes, but is not limited to, before, during, or after the operation of any portion of any of the other exemplary methods described in part in FIGS. 2A, 2B, 3, and 4. For example, block 201 (collecting articles from news sites) could be operating contemporaneously with a step of determining a score for a cluster in block 215 as well as a step of consolidating two other clusters into a single cluster in block 403. Further, steps of the methods in FIGS. 2A, 2B, 3, and 4 could be operating simultaneously on different clusters. For example, block 215 (determining a score for a cluster) could operate on a first cluster, at the same time that block 303 (determining a value for a each article in a cluster) operates on a second cluster.

The system as described substantially above may be done using a single-threaded or a multi-threaded application, processor, and/or computer system. In some embodiments, each of the methods in FIGS. 2A, 2B, 3, and 4 would be running in their own threads, so that an operation in any one of them could interrupt another method in order to process data. In some embodiments, the system may run in a completely unthreaded or event-driven manner. In other embodiments, a hybrid of the threading and event-driven approaches may be used.

Other embodiments will be apparent to those skilled in the art from consideration of the specification and practice disclosed herein. It is intended that the specification and examples be considered as examples only, with a true scope and spirit being indicated by the following claims.

1. A computer-implemented method for scoring at least one topic in a network environment, comprising:
identifying, with at least one processor, a plurality of content items accessible through a network;
identifying content items as corresponding to a topic, based at least in part on contents of the content items;
for each determined topic:
creating a cluster corresponding to the topic,
for each content item associated with the topic corresponding to the created cluster, creating a reference to the content item in the cluster,
selecting a representative title to represent the cluster, based on first criteria, and
generating a score for the cluster, based at least in part on a number of content items in the cluster whose contents comprise less than a percentage of content from at least one other content item in the cluster.

2. (canceled)

3. The method of claim 1, wherein the first criteria comprises at least one of:
repeated terms in the titles or headlines of each content item in the cluster,
the title or headline that has the most words which overlap with the other titles or headlines of other content items in the cluster, or
the title or headline that has the most words which overlap with the other titles or headlines of each other unique content item in the cluster; and
wherein creating each cluster further comprises:
storing, in each cluster, a date and time of each cluster's creation; and
storing, in each cluster, the category of the topic corresponding to the cluster.

4. The method of claim 1, further comprising, for each cluster:
generating a value for each content item in the cluster, based on second criteria;
selecting a representative content item to represent the cluster, based at least in part on the value for each content item in the cluster; and
selecting a representative image to represent the cluster, based on third criteria.

5. The method of claim 4, wherein
the second criteria comprises at least one of: the content item is from an owned-and-operated news source, the content item is from a major news source, the content item is from a news source that is relevant to the corresponding topic, the content item is at least a certain length, the content item has an image, the content item is accessible to any user on the network, or the content item is the most recent article in the cluster; and
the third criteria comprises at least one of: the image is from the representative content item, the image is from a content item from an owned-and-operated news source, the image is from a content item from a major news source, the image is from a content item from a news source that is relevant to the corresponding topic, the image is from a content item with a certain length, or the image is from the most recent content item in the cluster.

6. The method of claim 4, further comprising:
receiving a command to change the representative content item, the representative title, or the representative image.

7. The method of claim 1, further comprising:
identifying a second plurality of content items;
determining the topic of each story in the second plurality of content items;
for each determined topic whose corresponding cluster is not closed:
placing the articles from the second plurality of content items determined to be about the topic into the cluster, based at least in part on the topic, and
generating a new score for the cluster, based at least in part on the new number of content items in the cluster.

8. The method of claim 7, further comprising:
determining that no content item has been determined to correspond to a particular topic;
closing, based on the determination, the cluster corresponding to the particular topic; and
storing, in the cluster, a date and time that the particular cluster was closed.

9. The method of claim 1, further comprising:
receiving a command to split one cluster into multiple clusters representing multiple topics respectively;
for each new cluster:
selecting a new representative title, a new representative content item, and a new representative image, to represent the cluster; and
generating a new score for the cluster, based at least in part on a new number of content items in the cluster.

10. The method of claim 1, further comprising:
receiving a command to consolidate multiple clusters representing multiple topics respectively into a single cluster representing a single topic; and
selecting a new representative title, a new representative content item, and a new representative image, to represent the cluster; and
generating a new score for the cluster, based at least in part on a new number of content items in the cluster.

11. The method of claim 1, further comprising:
ordering the clusters based at least in part on each cluster's respective generated score.

12. A system comprising:
a storage device for storing a set of programmable instructions; and
at least one processor that executes the set of programmable instructions to:
identify a plurality of content items accessible through a network;
identify content items as corresponding to a topic, based at least in part on contents of the content items;
for each determined topic:
create a cluster corresponding to the topic,
for each content item that is associated with the topic corresponding to the created cluster, create a reference to the content item in the cluster,
select a representative title to represent the cluster, based on first criteria, and
generate a score for the cluster, based at least in part on a number of content items in the cluster whose contents comprise less than a percentage of content from at least one other content item in the cluster.

13. (canceled)

14. The system of claim 12, wherein the first criteria comprises at least one of:
repeated terms in the titles or headlines of each content item in the cluster,
the title or headline that has the most words which overlap with the other titles or headlines of other content items in the cluster, or
the title or headline that has the most words which overlap with the other titles or headlines of each other unique content item in the cluster; and
wherein creating each cluster further comprises:
storing, in each cluster, a date and time of each cluster's creation; and
storing, in each cluster, the category of the topic corresponding to the cluster.

15. The system of claim 12, wherein the at least one processor is further configured to, for each cluster:
generate a value for each content item in the cluster, based on second criteria;
select a representative content item to represent the cluster, based at least in part on the value for each content item in the cluster;
select a representative image to represent the cluster, based on third criteria.

16. The system of claim 15, wherein:
the second criteria comprises at least one of: the content item is from an owned-and-operated news source, the content item is from a major news source, the content item is from a news source that is relevant to the corresponding topic, the content item is at least a certain length, the article has an image, the content item is accessible to any user on the network, or the content item is the most recent content item in the cluster; and
wherein the third criteria comprises at least one of: the image is from the representative content item, the image is from a content item from an owned-and-operated news source, the image is from a content item from a major news source, the image is from a content item from a news source that is relevant to the corresponding topic, the image is from a content item with a certain length, or the image is from the most recent content item in the cluster.

17. The system of claim 15, wherein the at least one processor is further configured to:
receive a command to change the representative content item, the representative title, or the representative image.

18. The system of claim 12, wherein the at least one processor is further configured to:
identify a second plurality of content items;
determine the topic of each story in the second plurality of content items;
for each determined topic whose corresponding cluster is not closed:
place the content items from the second plurality of articles determined to be about the topic into the cluster, based at least in part on the topic, and
generate a new score for the cluster, based at least in part on the new number of content items in the cluster.

19. The system of claim 18, wherein the processor is further configured to:
determine that no content item has been determined to correspond to a particular topic;
close the cluster corresponding to the particular topic; and
store, in the cluster, a date and time that the particular cluster was closed.

20. The system of claim 12, wherein the processor is further configured to:
receive a command to split one cluster into multiple clusters representing multiple topics respectively;
for each new cluster:
select a new representative title, a new representative content item, and a new representative image, to represent the cluster; and
generate a new score for the cluster, based at least in part on a new number of content items in the cluster.

21. The system of claim 12, wherein the processor is further configured to:
receive a command to consolidate multiple clusters representing multiple topics respectively into a single cluster representing a single topic; and
select a new representative title, a new representative content item, and a new representative image, to represent the cluster; and
generate a new score for the cluster, based at least in part on a new number of content items in the cluster.

22. The system of claim 12, wherein the processor is further configured to order the clusters based at least in part on each cluster's respective generated score.
